(19) United States
(12) Patent Application Publication
(10) Pub. No.: US 2025/0050437 A1
(43) Pub. Date: Feb. 13, 2025

(54) WORK MACHINE

(71) Applicant: Koki Holdings Co., Ltd., Tokyo (JP)

(72) Inventors: Ken INUI, Ibaraki (JP); Keigo ISEDA, Ibaraki (JP)

(73) Assignee: Koki Holdings Co., Ltd., Tokyo (JP)

(21) Appl. No.: 18/715,736

(22) PCT Filed: Dec. 2, 2022
(86) PCT No.: PCT/JP2022/044623

§ 371 Date: Jun. 3, 2024

(30) Foreign Application Priority Data
Dec. 3, 2021 (JP) 2021-197267

(51) Int. Cl. B23D 49/16; B23D 51/16

(52) U.S. Cl. CPC B23D 49/162; B23D 51/16

(57) ABSTRACT

A work machine includes: a motor; a drive mechanism, connected to the motor and operating a tip tool; and a case, accommodating the drive mechanism. The drive mechanism includes: a first drive member, rotationally driven about an axis by the motor; a second drive member, reciprocally driven by the motor; and a support member, fixed to the case, restricting movement of the first drive member in a direction of the axis, and supporting the second drive member so that the second drive member is reciprocally drivable.

### TECHNICAL FIELD

The present invention relates to a work machine.

### RELATED ART

A saber saw (work machine) described in Patent Document 1 below includes a main body case accommodated in a gear housing, a gear part accommodated in the main body case, and a plunger connected to the gear part. A blade (tip tool) is attached to a front end of the plunger. A driving force of a motor is transmitted to the plunger via the gear part, thereby reciprocating the plunger in a front-rear direction together with the blade. Accordingly, cutting can be performed on a material to be cut. That is, the gear part and the plunger for operating the tip tool are configured as a drive mechanism for operating the tip tool.

### PRIOR-ART DOCUMENTS

### Patent Documents

Patent Document 1: Japanese Patent Laid-open No. 2019-209455

### SUMMARY OF THE INVENTION

### Problems to be Solved by the Invention

Here, in the above drive mechanism of the work machine, an operating drive member is operably received by a support member such as a bearing. Hence, in the drive mechanism, if a support member is set for each drive member, the number of components of the drive mechanism increases, which may lead to an increase in the cost of the drive mechanism and the work machine. Hence, it is desirable for the work machine to have a configuration in which an increase in the number of components can be suppressed and the cost can be reduced.

In consideration of the above facts, an object of the present invention is to provide a work machine in which an increase in the number of components can be suppressed and the cost can be reduced.

### Means for Solving the Problems

One or more embodiments of the present invention provides a work machine including: a motor; a drive mechanism, connected to the motor and operating a tip tool; and a case, accommodating the drive mechanism. The drive mechanism is configured to include: a first drive member and a second drive member, operated by power of the motor; and a receiving member, fixed to the case and drivably supporting the first drive member and the second drive member. Preferably, the first drive member is configured to be rotationally driven about an axis by the motor. The second drive member is configured to be reciprocally driven by the motor. The support member is configured to restrict movement of the first drive member in a direction of the axis, and support the second drive member so that the second drive member is reciprocally drivable.

One or more embodiments of the present invention provides a work machine as follows. The receiving member is configured to include: a first receiving part, supporting the first drive member; and a second receiving part, supporting the second drive member. The first receiving part and the second receiving part are respectively provided in different portions of the receiving member.

One or more embodiments of the present invention provides a work machine as follows. The receiving member and the first drive member are arranged to face each other in a first direction. The first receiving part is configured as a facing surface facing the first drive member. The second receiving part is configured as a slit which is formed in an intermediate part in the first direction of the receiving member and into which the second drive member is inserted. One or more embodiments of the present invention provides a work machine as follows. The first drive member is a gear configured to be rotatable with the first direction as an axial direction. One or more embodiments of the present invention provides a work machine as follows. The receiving member is arranged to face an outer peripheral part of the gear in the first direction.

One or more embodiments of the present invention provides a work machine as follows. The second drive member is formed in an elongated shape extending in a second direction orthogonal to the first direction, and the second drive member reciprocates in the second direction when the drive mechanism is operated. The tip tool is connected to one end of the second drive member, and the other end of the second drive member is movably guided in the second direction by the second receiving part.

One or more embodiments of the present invention provides a work machine as follows. A direction orthogonal to the first direction and the second direction is a third direction. The drive mechanism includes a pair of the receiving members, and the pair of the receiving members are arranged spaced apart in the third direction.

One or more embodiments of the present invention provides a work machine as follows. The first drive member is provided with a connecting part. The connecting part connects the first drive member and the second drive member, transmits power of the motor to the second drive member, and is arranged between the pair of the receiving members.

One or more embodiments of the present invention provides a work machine as follows. The drive mechanism includes a third drive member operated by the power of the motor. The third drive member is arranged opposite the first drive member with respect to the receiving member, and the receiving member operably receives the third drive member.

One or more embodiments of the present invention provides a work machine as follows. The third drive member is connected to the first drive member by the connecting part.

One or more embodiments of the present invention provides a work machine as follows. The receiving member is configured as a single component.

One or more embodiments of the present invention provides a work machine as follows. The receiving member is composed of a sintered material, and the receiving member is impregnated with a lubricant.

One or more embodiments of the present invention provides a work machine including: a motor; an output part, operated by a driving force of the motor; a transmission gear, rotated by the driving force of the motor and transmitting the driving force to the output part; a case, accommodating the transmission gear; a support shaft, fixed to the case and rotatably supporting the transmission gear; and an elastic body, provided in the case. The transmission gear is configured to be movable relative to the support shaft, and the elastic body elastically deforms when the transmission gear moves relative to the support shaft.

One or more embodiments of the present invention provides a work machine including: a motor; a drive mechanism, connected to the motor and operating a tip tool; and a case, accommodating the drive mechanism. The case is configured to include: a case body of a box shape, having an opening that is open to one side in a first direction; and a cover, closing the opening. The drive mechanism is arranged so as not to protrude further to one side in the first direction than the opening.

### Effects of the Invention

According to one or more embodiments of the present invention, an increase in the number of components can be suppressed and costs can be reduced.

### BRIEF DESCRIPTION OF THE DRAWINGS

FIG. 1 is a side view of an electric cutting device according to the present embodiment as viewed from the right side.

FIG. 2 is a side view showing the inside of the electric cutting device shown in FIG. 1 as viewed from the right side.

FIG. 3 is a vertical sectional view showing the inside of an inner case shown in FIG. 2 as viewed from the right side.

FIG. 4 is a sectional view (sectional view taken along line 4-4 in FIG. 3) showing the inside of a rear part of the inner case shown in FIG. 3 as viewed from the front side.

FIG. 5 is a sectional view (sectional view taken along line 5-5 in FIG. 2) showing a fastened and fixed state between a case cover and a case body at a rear end of the inner case shown in FIG. 2 as viewed from the rear side.

FIG. 6 is a perspective view of the inner case shown in FIG. 2 with the case cover removed from the case body, as viewed obliquely from the front left side.

FIG. 7 is a perspective view of the case body of the inner case shown in FIG. 6 as viewed obliquely from the front left side.

FIG. 8 is a plan view showing a state in which a drive mechanism shown in FIG. 6 is accommodated in the case body with a vibration reduction mechanism part removed.

FIG. 9 is an exploded perspective view of a reciprocating motion mechanism part of the drive mechanism shown in FIG. 3 as viewed obliquely from the front left side.

FIG. 10 is an exploded perspective view of the vibration reduction mechanism part of the drive mechanism shown in FIG. 3 as viewed obliquely from the front left side.

### DESCRIPTION OF THE EMBODIMENTS

An electric cutting device 10 as a work machine according to the present embodiment will be below described with reference to the drawings. Arrows UP, FR, and RH shown as appropriate in the drawings respectively indicate an upper side, a front side, and a right side of the electric cutting device 10. In the following description, unless otherwise specified, up-down, front-rear, and left-right directions as used indicate an up-down direction, a front-rear direction, and a left-right direction of the electric cutting device 10. The up-down direction corresponds to a first direction of the present invention, the front-rear direction corresponds to a second direction of the present invention, and the left-right direction corresponds to a third direction of the present invention.

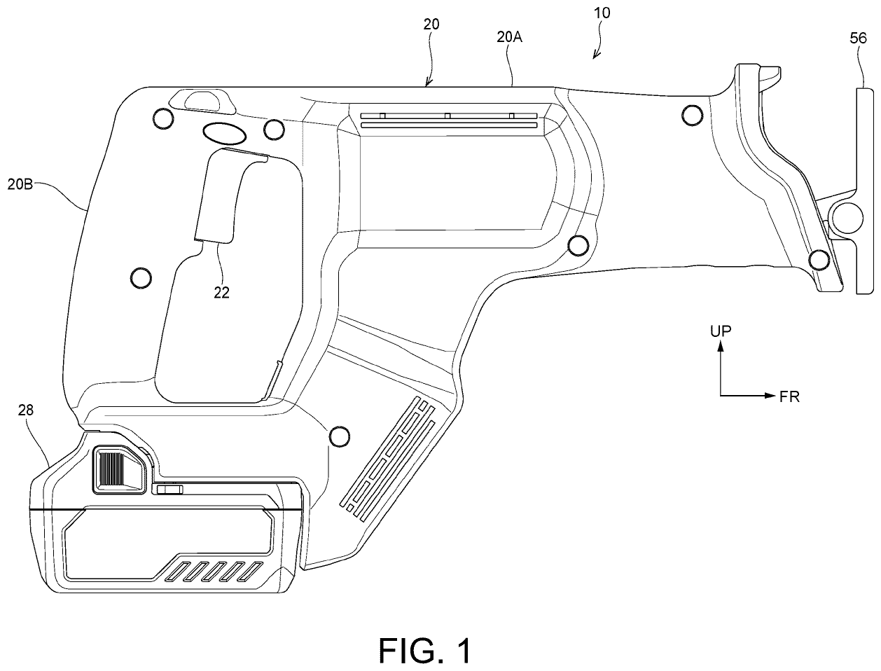

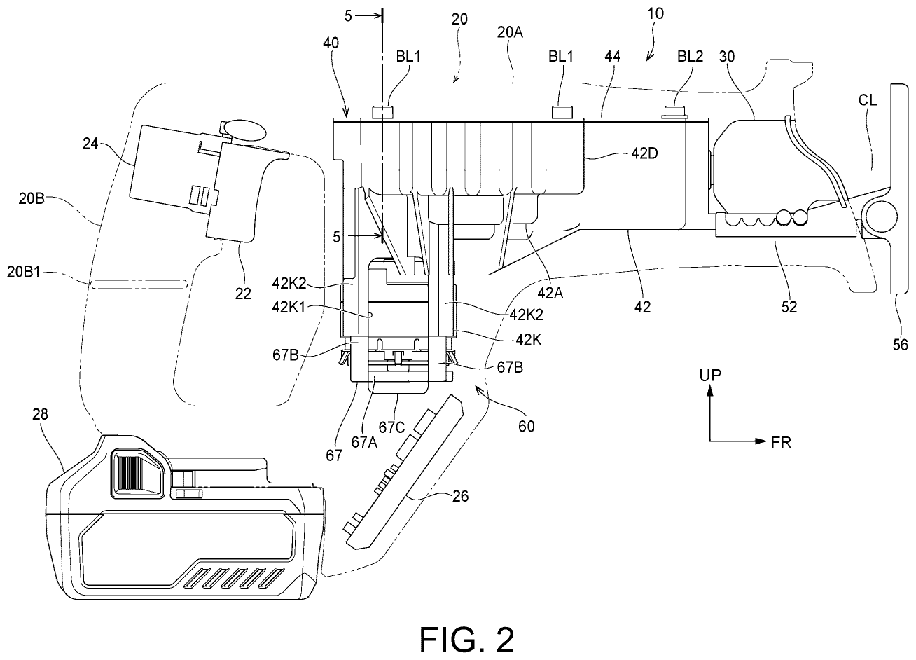

The electric cutting device 10 is configured as an electric tool that performs cutting on a material to be cut, such as a pipe. As shown in FIG. 1 and FIG. 2, the electric cutting device 10 is configured to include: a housing 20, constituting an outer shell of the electric cutting device 10; an inner case 40, as a case accommodated and fixed within the housing 20; a motor 60, as a drive source assembled to the inner case 40; and a drive mechanism 70, accommodated in the inner case 40. Each configuration of the electric cutting device 10 will be described below.

### (Regarding Housing 20)

The housing 20 as a whole is formed in a substantially hollow columnar shape extending in the front-rear direction. The housing 20 is composed of housing members split into two in the left-right direction. The left and right housing members are assembled to each other to form the housing 20. The housing 20 is configured to include: a front housing part 20A, constituting a front part of the housing 20; and a handle housing part 20B, as a handle constituting a rear end of the housing 20. The front housing part 20A extends in the front-rear direction. A rear end of the front housing part 20A is bent downward. The handle housing part 20B extends in the up-down direction. Both ends in the up-down direction of the handle housing part 20B are bent forward and connected to the rear end of the front housing part 20A. During cutting, an operator grasps the handle housing part 20B so as to perform cutting.

A trigger 22 is provided in an upper end portion of the handle housing part 20B. The trigger 22 protrudes forward from the handle housing part 20B and is configured to allow a rearward pulling operation. In the handle housing part 20B, a switch mechanism part 24 is provided on the rear side of the trigger 22. The switch mechanism part 24 includes a switch (not shown) operated by the trigger 22. The switch is electrically connected to a control part 26. The control part 26 is provided at a lower end on the rear end side of the front housing part 20A. An output signal corresponding to an operation of the trigger 22 is output from the switch to the control part 26.

A battery 28 is detachably attached to the lower end of the handle housing part 20B from the rear side. The battery 28 is electrically connected to the control part 26 and the motor 60 (described later). A configuration is achieved in which electric power is supplied from the battery 28 to the control part 26 and the motor 60.

### (Regarding Inner Case 40)

As shown in FIG. 2 to FIG. 8, the inner case 40 as a whole is formed in a substantially rectangular parallelepiped box shape extending in the front-rear direction. The inner case 40 is accommodated within an upper part of the front housing part 20A, is sandwiched from outside in the left-right direction between the housing members constituting the housing 20, and is fixed to the housing 20. The inner case 40 is configured to include a case body 42, and a case cover 44 as a cover. The case cover 44 is fastened and fixed to the case body 42.

### (Regarding Case Body 42)

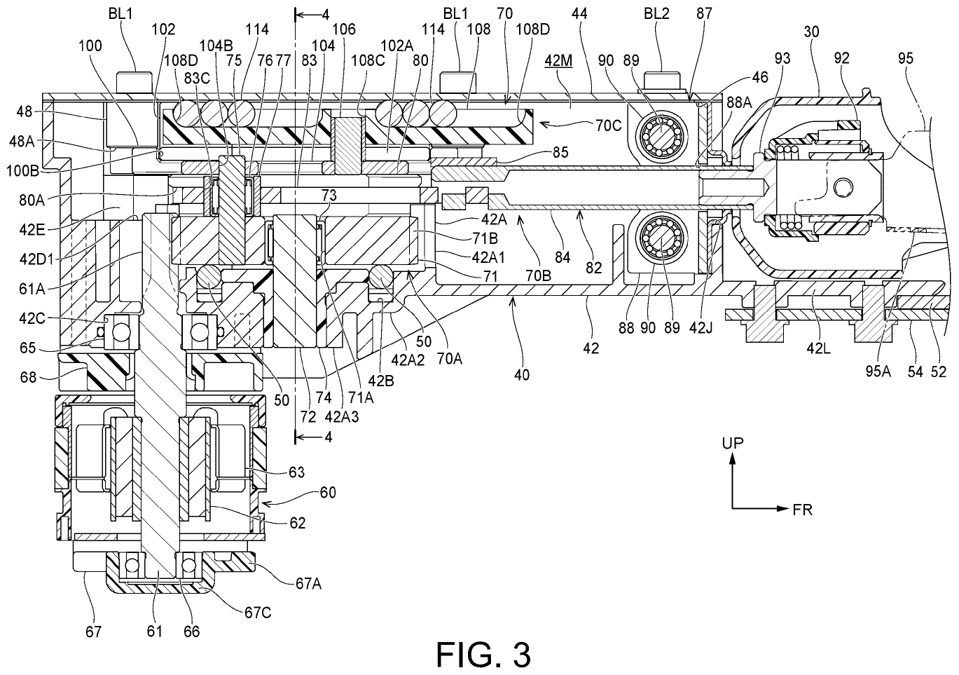

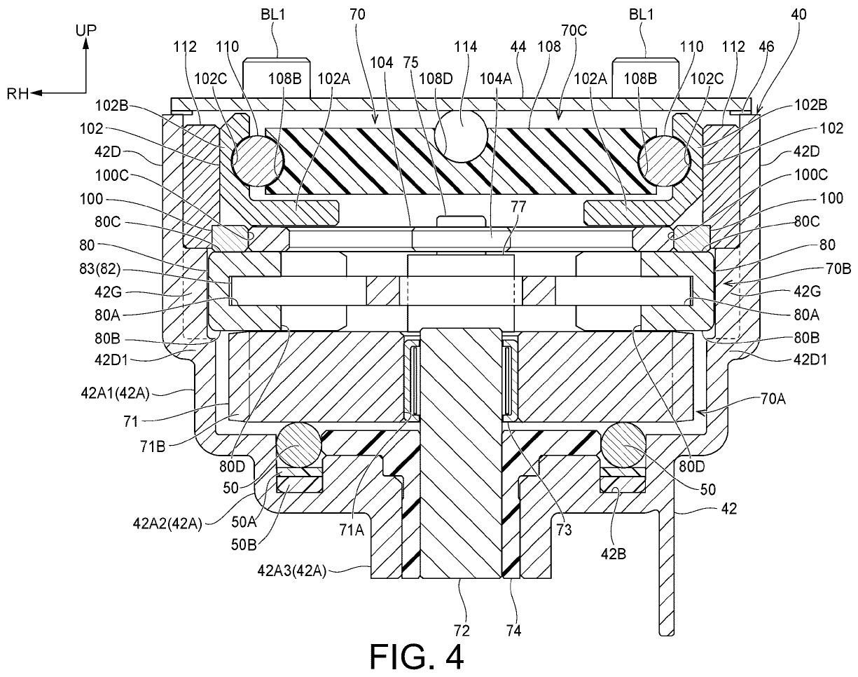

The case body 42 is made of metal and is molded by casting. The case body 42 as a whole is formed in a substantially rectangular box shape extending in the front-rear direction and open upward. A gear accommodation part 42A (see FIG. 4) that accommodates a gear 71 (described later) is formed at a bottom in a rear part of the case body 42. The gear accommodation part 42A is formed in a two-step stepped cylindrical shape with the up-down direction as an axial direction. Specifically, the gear accommodation part 42A is configured to include: an upper accommodation part 42A1, constituting an upper part of the gear accommodation part 42A; an intermediate accommodation part 42A2, constituting an intermediate part in the up-down direction of the gear accommodation part 42A; and a lower accommodation part 42A3, constituting a lower part of the gear accommodation part 42A. A diameter of the intermediate accommodation part 42A2 is set larger than a diameter of the lower accommodation part 42A3, and a diameter of the upper accommodation part 42A1 is set larger than the diameter of the intermediate accommodation part 42A2. The upper accommodation part 42A1 protrudes upward from a bottom wall of the case body 42. Both side portions in the left-right direction of the upper accommodation part 42A1 protrude outward in the left-right direction from sidewalls of the case body 42, and constitute an outer shell of the case body 42. A ball groove 42B (see FIG. 3 and FIG. 4) is formed along a circumferential direction at an outer periphery of a lower surface of the intermediate accommodation part 42A2. The ball groove 42B is formed over the entire circumference of the intermediate accommodation part 42A2 in the circumferential direction. A plurality of rolling balls 50 are provided inside the ball groove 42B. The plurality of rolling balls 50 are arranged side by side along the circumferential direction of the ball groove 42B. An upper end of the rolling ball 50 is arranged on the upper side of a bottom surface of the upper accommodation part 42A1, and is arranged within the upper accommodation part 42A1. A thrust washer 50A and a buffer rubber 50B are provided below the rolling ball 50. The buffer rubber 50B corresponds to an elastic body of the present invention.

At the bottom of the case body 42, on the rear side of the gear accommodation part 42A, a shaft accommodation part 42C (see FIG. 3) is formed as a communication part for accommodating a portion of a drive shaft 61 of the motor 60 (described later). The shaft accommodation part 42C is formed in a substantially stepped cylindrical shape with the up-down direction as the axial direction. A diameter of an upper part of the shaft accommodation part 42C is set smaller than a diameter of a lower part of the shaft accommodation part 42C. The inside of the shaft accommodation part 42C is penetrated in the up-down direction, and the inside and the outside of the case body 42 are communicated by the shaft accommodation part 42C. The shaft accommodation part 42C is arranged to overlap a rear end of the gear accommodation part 42A in plan view. The inside of the shaft accommodation part 42C and the inside of the upper accommodation part 42A1 communicate with each other.

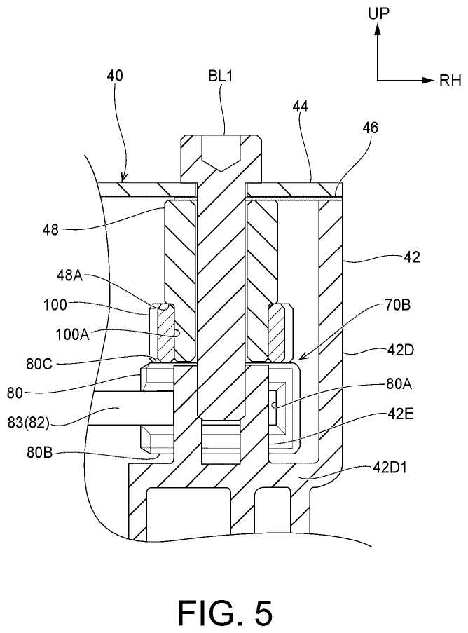

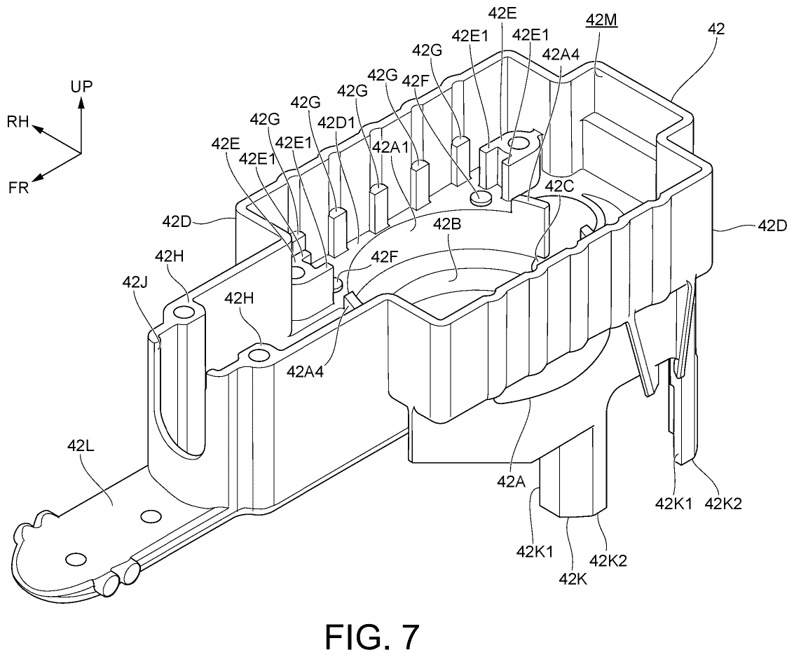

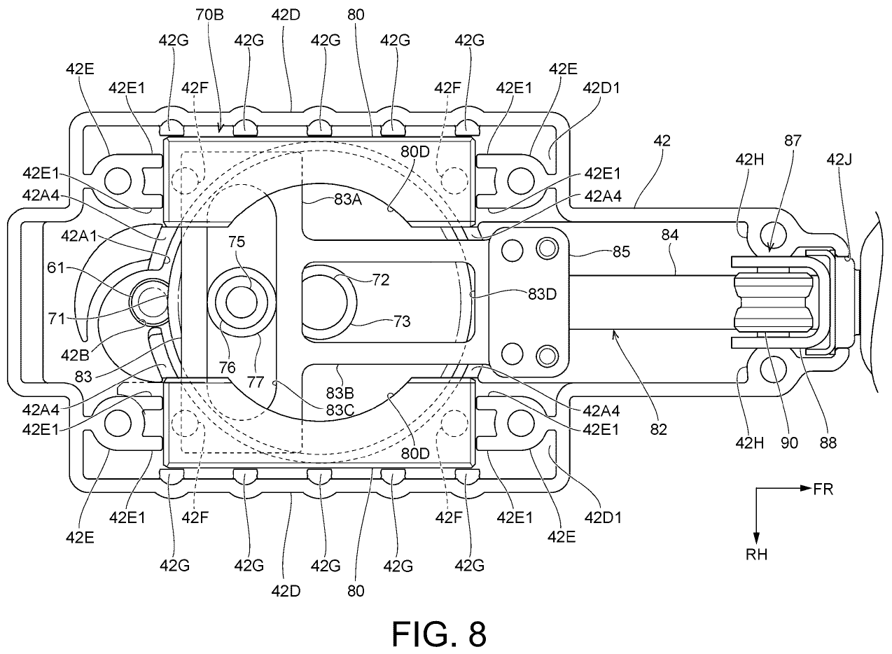

As shown in FIG. 7 and FIG. 8, a left-right pair of projecting parts 42D projecting outward in the left-right direction are formed in an upper part of the rear part of the case body 42. The projecting part 42D protrudes on both sides in the front-rear direction with respect to the gear accommodation part 42A. An upper end of the upper accommodation part 42A1 of the gear accommodation part 42A is connected to a bottom wall 42D1 of the projecting part 42D. The bottom walls 42D1 of the left and right projecting parts 42D are connected to each other on the rear side of the gear accommodation part 42A. At a front end and a rear end of the upper accommodation part 42A1 of the gear accommodation part 42A, a positioning piece 42A4 is formed. The positioning piece 42A4 protrudes upward from the upper accommodation part 42A1 and the bottom wall 42D1 of the projecting part 42D. A rear fixing boss 42E is formed at each of outer ends in the front-rear direction of the bottom wall 42D1 of the projecting part 42D. The rear fixing boss 42E is formed in a substantially cylindrical shape with the up-down direction as the axial direction, and protrudes upward from the bottom wall 42D1 (see FIG. 5). An upper end surface of the rear fixing boss 42E is arranged lower than an upper end surface of the case body 42. A female thread is formed at an inner periphery of the rear fixing boss 42E. A left-right pair of fixing ribs 42E1 are formed on the rear fixing boss 42E. The fixing rib 42E1 extends from an outer periphery on both sides in the left-right direction of the rear fixing boss 42E toward an inner side in the front-rear direction of the projecting part 42D.

A front-rear pair of installation parts 42F for installing a guide metal 80 (described later) are formed on the bottom wall 42D1 of the pair of projecting parts 42D. The installation part 42F is formed in a substantially disk shape with the up-down direction as a thickness direction, protrudes upward from the bottom wall 42D1, and is arranged inside the projecting part 42D in the front-rear direction with respect to the rear fixing boss 42E. In the pair of projecting parts 42D, between a front-rear pair of rear fixing bosses 42E, a plurality of (five in the present embodiment) positioning ribs 42G are each integrally formed. The positioning rib 42G is formed in a substantially rectangular columnar shape, extends upward from the bottom wall 42D1 of the projecting part 42D, and is connected to left and right sidewalls of the projecting part 42D. The plurality of positioning ribs 42G are arranged side by side at regular intervals in the front-rear direction.

A left-right pair of front fixing bosses 42H are formed at a front end of the case body 42. The front fixing boss 42H is formed in a substantially cylindrical shape with the up-down direction as the axial direction, and extends upward from the bottom wall of the case body 42. The front fixing boss 42H is connected to the left and right sidewalls of the case body 42. An upper end surface of the front fixing boss 42H is arranged flush with the upper end surface of the case body 42. A female thread is formed at an inner periphery of the front fixing boss 42H.

On a front wall of the case body 42, an insertion part 42J for insertion of a plunger 82 (described later) therethrough is formed. The insertion part 42J is formed in a groove shape open upward, and is penetrated in the front-rear direction. At a rear end of the case body 42, a motor holder 42K is formed as a holding part for holding the motor 60 (described later). The motor holder 42K is formed in a substantially rectangular cylindrical shape protruding downward from the case body 42 and arranged coaxially with the shaft accommodation part 42C. A notch 42K1 open downward is formed in each of sidewalls of the motor holder 42K. That is, it can be said that the motor holder 42K is constituted by pillars 42K2 in four places.

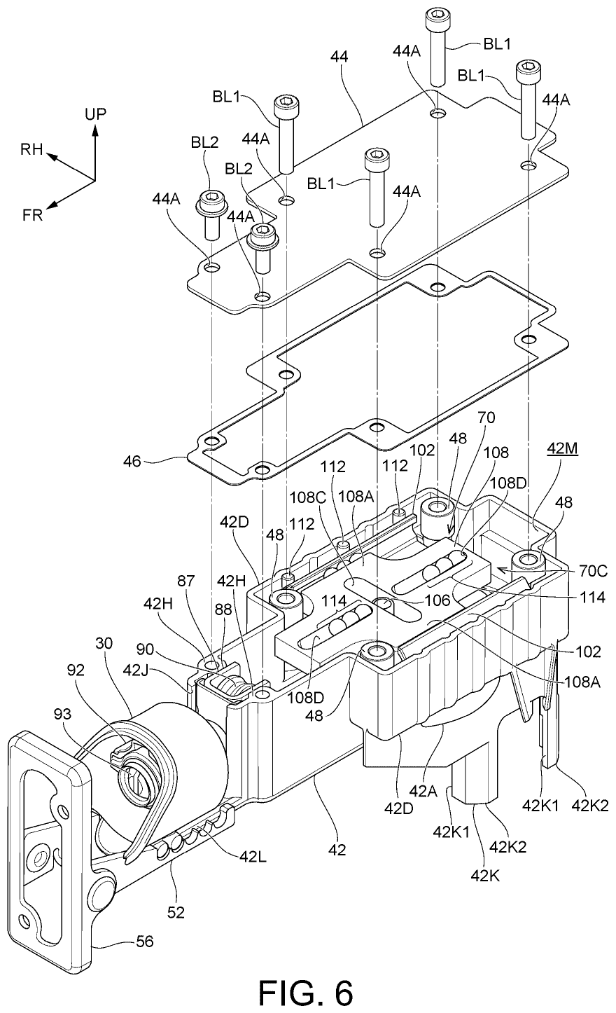

An attachment piece 42L is integrally formed at a lower end of the front wall of the case body 42. The attachment piece 42L is formed in a substantially rectangular plate shape with the up-down direction as a plate thickness direction, and extends forward from the front wall of the case body 42. As shown in FIG. 3 and FIG. 6, a fixing plate 52 is provided on the lower side of the attachment piece 42L. The fixing plate 52 is formed in a substantially U-shaped plate shape open upward as viewed from the front side, and is fastened and fixed to the attachment piece 42L via a stay 54. As shown in FIG. 6, a base 56 is provided at a front end of the fixing plate 52. The fixing plate 52 is formed in a substantially rectangular frame shape with the up-down direction as a longitudinal direction in front view. A lower end portion of the base 56 is rotatably connected to the front end of the fixing plate 52 with the left-right direction as the axial direction.

### (Regarding Case Cover 44)

As shown in FIG. 6, the case cover 44 is composed of a metal plate material and is molded by pressing (punching). The case cover 44 is formed in a substantially rectangular flat plate shape with the up-down direction as the plate thickness direction and extending in the front-rear direction. An outer shape of the case cover 44 is formed to match an outer shape of the upper end of the case body 42 in plan view. At an outer periphery of the case cover 44, a fixing hole 44A is formed through in a position corresponding to the rear fixing boss 42E and the front fixing boss 42H of the case body 42. As a fixing bolt BL1 as a fastening member is inserted from the upper side into the fixing hole 44A corresponding to the rear fixing boss 42E and is screwed into the inner periphery of the rear fixing boss 42E, a fixing bolt BL2 as a fastening member is inserted from the upper side into the fixing hole 44A corresponding to the front fixing boss 42H and is screwed into the inner periphery of the front fixing boss 42H. Accordingly, the case cover 44 is fixed to the case body 42, and an opening 42M on the upper side of the case body 42 is closed by the case cover 44.

A packing 46 is provided between the outer periphery (lower surface) of the case cover 44 and (an upper surface of) the case body 42. The packing 46 is composed of an elastic material such as rubber, and is formed in a frame shape with the up-down direction as the thickness direction. The packing 46 is set to have a relatively small thickness. Accordingly, the opening 42M of the case body 42 is hermetically closed by the packing 46 and the case cover 44.

Also as shown in FIG. 5, a fixing sleeve 48 as a fixing tool is provided between the case cover 44 (packing 46) and the rear fixing boss 42E. The fixing sleeve 48 is formed in a substantially cylindrical shape with the up-down direction as the axial direction. The fixing bolt BL1 is inserted through the fixing sleeve 48. That is, the case cover 44 is fastened and fixed to the rear fixing boss 42E via the fixing sleeve 48. A stepped part 48A is formed in an intermediate part in the up-down direction of an outer periphery of the fixing sleeve 48. A diameter of an upper part of the fixing sleeve 48 is set larger than a diameter of a lower part of the fixing sleeve 48.

### (Regarding Motor 60)

As shown in FIG. 2 and FIG. 3, the motor 60 is configured as a brushless motor, and is arranged on the lower side of the rear end of the case body 42. The motor 60 includes a drive shaft 61 as a transmission member. The drive shaft 61 extends in the up-down direction. A gear part 61A composed of a helical gear is formed at an upper end of the drive shaft 61. The upper end portion of the drive shaft 61 is accommodated within the shaft accommodation part 42C of the case body 42. The upper end of the drive shaft 61 protrudes upward from the shaft accommodation part 42C and is arranged within the rear end of the gear accommodation part 42A. The upper end portion of the drive shaft 61 is rotatably supported by a motor bearing 65 fixed to the lower part of the shaft accommodation part 42C. A lower end of the drive shaft 61 is rotatably supported by a motor bearing 66. The motor bearing 66 is fixed to a bearing holder 67 assembled to the case body 42.

The bearing holder 67 includes a holder base 67A, and arms 67B in four places. The holder base 67A is formed in a substantially rectangular plate shape with the up-down direction as the thickness direction. A bearing holder 67C protruding downward and open upward is formed in a substantially central part of the holder base 67A. The motor bearing 66 is fitted into the bearing holder 67C and fixed to the bearing holder 67. The arm 67B extends upward from four corners of the holder base 67A. An upper end of the arm 67B is arranged inside the motor holder 42K of the case body 42, and is assembled to the motor holder 42K.

A rotor 62 and a stator 63 of the motor 60 are arranged radially outside a lower part of the drive shaft 61 and are arranged inside the motor holder 42K. A fan 68 is provided at the upper end portion of the drive shaft 61 so as to be integrally rotatable. The fan 68 is arranged in close proximity to the lower side of the motor bearing 65. The fan 68 is configured as a centrifugal fan.

### (Regarding Drive Mechanism 70)

As shown in FIG. 3 and FIG. 6, the drive mechanism 70 is accommodated inside the inner case 40. The drive mechanism 70 is configured to include: a gear mechanism part 70A as a first drive mechanism part; a reciprocating motion mechanism part 70B as a second drive mechanism part; and a vibration reduction mechanism part 70C as a third drive mechanism part.

### (Regarding Gear Mechanism Part 70A)

As shown in FIG. 3 and FIG. 4, the gear mechanism part 70A is configured with the gear 71 (transmission gear) as a first drive member as a main part. The gear 71 is formed in a substantially disk shape with the up-down direction as the thickness direction. The gear 71 is accommodated within the upper accommodation part 42A1 of the gear accommodation part 42A, and is placed on the upper side of the plurality of rolling balls 50. A gear hole 71A is formed through a central part of the gear 71. An upper end of a gear shaft 72 (support shaft) with the up-down direction as the axial direction is inserted into the gear hole 71A. The gear hole 71A is rotatably supported by the gear shaft 72 via a needle bearing 73. A lower part of the gear shaft 72 is supported by a bush 74 of a cylindrical shape. The bush 74 is provided inside the intermediate accommodation part 42A2 and the lower accommodation part 42A3 of the gear accommodation part 42A. As described above, the gear 71, while being rolling supported from the lower side by the rolling ball 50, is accommodated within the gear accommodation part 42A so as to be rotatable with the up-down direction as the axial direction. The rolling ball 50 receives a rotational force of the gear 71, rolls around the gear shaft 72, and moves in the circumferential direction. Since the rolling ball 50 is configured to roll on a surface of the gear 71, friction generated between the rolling ball 50 and the gear 71 is reduced. The rolling ball 50 is supported by the thrust washer 50A, and rolls on a surface of the thrust washer 50A during the rolling movement. Thus, friction generated between the rolling ball 50 and the thrust washer 50A is reduced.

A gear part 71B composed of a helical gear is formed at an outer periphery of the gear 71. The gear part 71B meshes with the gear part 61A of the drive shaft 61 of the motor 60. Accordingly, when the motor 60 operates (particularly when load on the motor 60 increases), as the gear 71 rotates, a thrust force in the up-down direction (mainly downward direction) is generated in the gear 71 by the meshing action between the gear part 61A and the gear part 71B that are composed of helical gears. Conversely, the gear part 61A and the gear part 71B that are composed of helical gears mesh with each other so that a downward thrust force is generated in the gear 71 when load on the motor 60 increases. In a specific example in which a thrust force is generated, when a blade 95 (described later) is moved rearward by the drive mechanism 70 to cut the material to be cut, a downward thrust force acts on the gear 71, so that the thrust force may be received by the rolling ball 50. Specifically, when the downward thrust force acts on the gear 71, the gear 71 moves relative to the gear shaft 72 (slides downward or is inclined with respect to the up-down direction), so that the movement may be received by the rolling ball 50. When the downward thrust force acts on the rolling ball 50, the thrust force is transmitted to the buffer rubber 50B (elastic body) via the thrust washer 50A. As a result, the thrust force is absorbed by the buffer rubber 50B, and a transmission mechanism for transmitting power of the motor 60 to the blade 95 is prevented from being damaged or deformed by the thrust force.

A crankpin 75 as a connecting part is provided in the gear 71 so as to be integrally rotatable. The crankpin 75 is formed in a substantially columnar shape with the up-down direction as the axial direction, is arranged in a position eccentric to a rotation axis line of the gear 71, and protrudes upward from the gear 71. A sleeve 77 of a cylindrical shape is rotatably provided on the crankpin 75 via a needle bearing 76. An upper end of the crankpin 75 protrudes upward from the needle bearing 76 and the sleeve 77.

### (Regarding Reciprocating Motion Mechanism Part 70B)

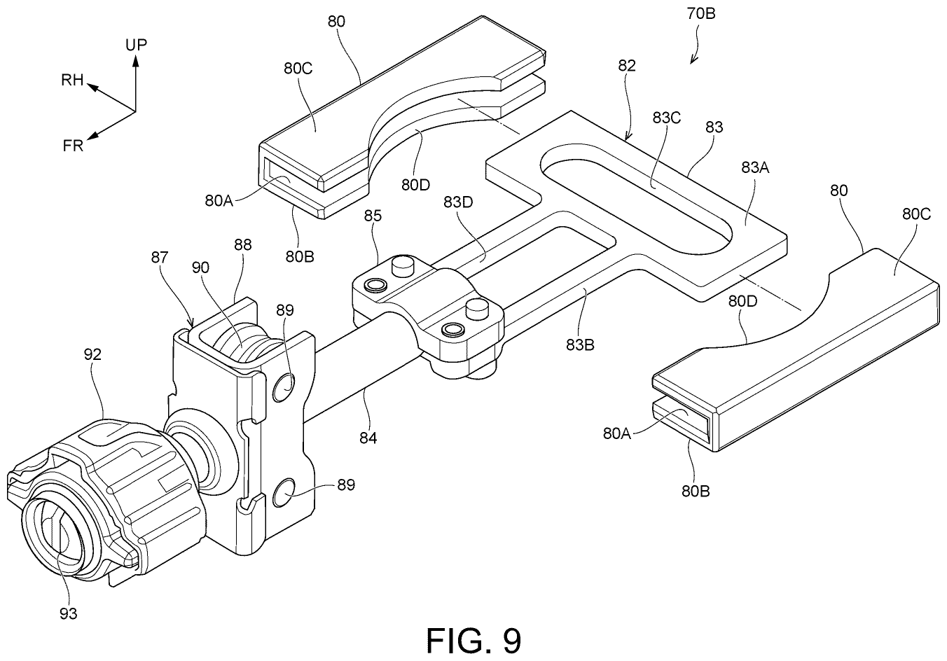

As shown in FIG. 3 to FIG. 6, FIG. 8, and FIG. 9, the reciprocating motion mechanism part 70B is accommodated in the case body 42 on the upper side of the gear mechanism part 70A. The reciprocating motion mechanism part 70B is configured to include: the guide metal 80, as a left-right pair of support members (receiving members); and the plunger 82 (output part), as a second drive member.

### (Regarding Guide Metal 80)

A left-right pair of guide metals 80 are composed of a sintered material, and the guide metal 80 is impregnated with a lubricant. The guide metal 80 is formed in a substantially rectangular plate shape with the front-rear direction as the longitudinal direction and the up-down direction as the thickness direction, and is formed in a substantially U-shape open inward in the left-right direction as viewed in the front-rear direction. That is, a slit 80A as a second receiving part (second support) is formed in an intermediate part in the up-down direction of the guide metal 80. The slit 80A is formed in a groove shape open inward in the left-right direction, and is penetrated in the front-rear direction. In the guide metal 80, a lower surface 80B as a first receiving part (first support) and an upper surface 80C are arranged along a surface orthogonal to the up-down direction.

As shown in FIG. 4 and FIG. 8, the guide metal 80 is accommodated in the projecting part 42D of the case body 42, and the lower surface 80B of the guide metal 80 is installed in the installation part 42F of the projecting part 42D. The guide metal 80 is arranged between the front-rear pair of rear fixing bosses 42E, and the position of the guide metal 80 in the front-rear direction is determined by the fixing rib 42E1 on the rear fixing boss 42E. The guide metal 80 is arranged between the positioning piece 42A4 and the positioning rib 42G of the case body 42, and the position of the guide metal 80 in the left-right direction is determined by the positioning piece 42A4 and the positioning rib 42G.

A relief recess 80D (see FIG. 8) is formed in an inner side part in the left-right direction of the intermediate part in the front-rear direction of the guide metal 80. The relief recess 80D is formed in a substantially arcuate concave shape centered on the rotation axis line of the gear 71 in plan view, is open inward in the left-right direction and is penetrated in the up-down direction. An edge of the relief recess 80D in the guide metal 80 is arranged in close proximity to an upper side of the outer periphery on both sides in the left-right direction of the gear 71. A predetermined gap is formed between the guide metal 80 and the gear 71 in the up-down direction. Accordingly, when an upward thrust force acts during rotation of the gear 71 and the gear 71 moves upward, the lower surface 80B of the guide metal 80 receives the thrust force so as to restrict upward movement of the gear 71. At this time, the outer periphery of the gear 71 slides on the lower surface 80B of the guide metal 80. That is, the guide metal 80 is configured as a stopping member that receives the gear 71 moving upward (to one side in a thrust direction) and restricts upward movement of the gear 71. The lower surface 80B of the guide metal 80 is configured as a receiving surface that receives the gear 71, and is also configured as a positioning surface that determines the position of the guide metal 80 (rear end of the reciprocating motion mechanism part 70B) in the up-down direction.

### (Regarding Plunger 82)

As shown in FIG. 3, FIG. 4, FIG. 8, and FIG. 9, the plunger 82 is formed in an elongated shape extending in the front-rear direction. The plunger 82 is configured to include: a connector 83, constituting a rear part of the plunger 82; and an output shaft 84, constituting a front part of the plunger 82. The connector 83 is formed in a substantially T-shaped plate shape with the up-down direction as the plate thickness direction. Specifically, the connector 83 is configured to include: a rear connector part 83A, extending in the left-right direction; and a front connector part 83B, extending forward from an intermediate part in the left-right direction of the rear connector part 83A. Both ends in the left-right direction of the rear connector part 83A are inserted into the slit 80A of the guide metal 80 so as to be movable in the front-rear direction. The connector 83 is supported by the left-right pair of guide metals 80 so as to be movable in the front-rear direction. The rear connector part 83A is arranged in close proximity to the inner side in the left-right direction of a bottom surface (outer side surface in the left-right direction) of the slit 80A. That is, the guide metal 80 is configured as a guide member that receives the operating connector 83 from both sides in the up-down direction and guides movement of the connector 83 in the front-rear direction. The guide metal 80 is also configured as a support member that slidably supports the connector 83 moving in the front-rear direction. That is, the guide metal 80 is a slide bearing.

A connecting hole 83C is formed through the rear connector part 83A. The connecting hole 83C is formed in an elongated hole shape with the left-right direction as the longitudinal direction. The crankpin 75, the needle bearing 76 and the sleeve 77 of the gear 71 are inserted into the connecting hole 83C so as to be movable in the left-right direction and engageable in the front-rear direction. Accordingly, the rotational force of the gear 71 is converted by the crankpin 75 including the sleeve 77, and the connector 83 (plunger 82) is configured to reciprocate in the front-rear direction. The crankpin 75 (sleeve 77) is arranged between the left-right pair of guide metals 80. When the gear 71 rotates, interference between the sleeve 77 and the guide metal 80 is suppressed by the relief recess 80D of the guide metal 80. A relief hole 83D is formed through the front connector part 83B except for a front end. The relief hole 83D is formed in a substantially rectangular shape extending in the front-rear direction.

The output shaft 84 is formed in a substantially bottomed cylindrical shape open forward. A rear end of the output shaft 84 is engaged with a front end of the connector 83 in the front-rear direction, and is connected to the front end of the connector 83 in a relatively immovable manner by a plunger sleeve 85. A front end portion of the output shaft 84 is rolling supported by an upper-lower pair of rollers 90 in a roller unit 87 provided at the front end of the case body 42.

The roller unit 87 is configured to includes a roller holder 88, an upper-lower pair of roller shafts 89, and an upper-lower pair of rollers 90. The roller holder 88 is formed in a substantially U-shaped plate shape open rearward in plan view, is arranged between the left and right front fixing bosses 42H of the case body 42, and is assembled to the case body 42. The roller shaft 89 is bridged between the left and right sidewalls of the roller holder 88 with the left-right direction as the axial direction. The roller shaft 89 is provided in each of an upper part and a lower part of the roller holder 88. The roller 90 is formed in a substantially disk shape with the left-right direction as the thickness direction. A central part of the roller 90 is rotatably supported by the roller shaft 89. The output shaft 84 is arranged between the upper-lower pair of rollers 90 and is rolling supported by the roller 90. A front end of the roller 90 is inserted through a holder hole 88A formed in a front wall of the roller holder 88 and the insertion part 42J of the case body 42, and protrudes forward from the front wall of the case body 42.

A blade attachment mechanism 92 is provided at the front end of the output shaft 84. The blade attachment mechanism 92 includes an attachment core 93. The attachment core 93 is formed in a substantially stepped columnar shape with the front-rear direction as the axial direction. The attachment core 93 is fixed to the output shaft 84 with a rear end of the attachment core 93 inserted into the front end of the output shaft 84.

As shown in FIG. 3 and FIG. 6, a dust sleeve 30 is provided at the front end of the output shaft 84. The dust sleeve 30 is formed in a substantially bottomed cylindrical shape open forward. The front end of the output shaft 84 is inserted through a bottom of the dust sleeve 30. The blade attachment mechanism 92 is arranged within the dust sleeve 30 of the housing 20. A front end of the dust sleeve 30 is assembled to the housing 20, and the dust sleeve 30 is arranged within a front end of the housing 20.

The blade 95 (see FIG. 3) as a tip tool is attached to the blade attachment mechanism 92. The blade 95 is formed in a substantially elongated plate shape with the left-right direction as the plate thickness direction and extending in the front-rear direction. A rear end of the blade 95 is attached to the blade attachment mechanism 92. In an attachment state of the blade 95, the blade 95 extends forward from the dust sleeve 30, is arranged on the front side of the housing 20, and is arranged within the base 56. A cutting portion 95A is formed at a lower end of the blade 95. The cutting portion 95A is formed over the entire blade 95 in the longitudinal direction. Accordingly, when the drive mechanism 70 operates, the blade 95 is configured to reciprocate in the front-rear direction together with the output shaft 84.

The reciprocating motion mechanism part 70B is arranged on the upper side of a central part 20B1 in the up-down direction of the handle housing part 20B in the housing 20. In detail, the central part 20B1 in the up-down direction of the handle housing part 20B is arranged lower than an axis line CL of the output shaft 84 of the reciprocating motion mechanism part 70B (see FIG. 2).

### (Regarding Vibration Reduction Mechanism Part 70C)

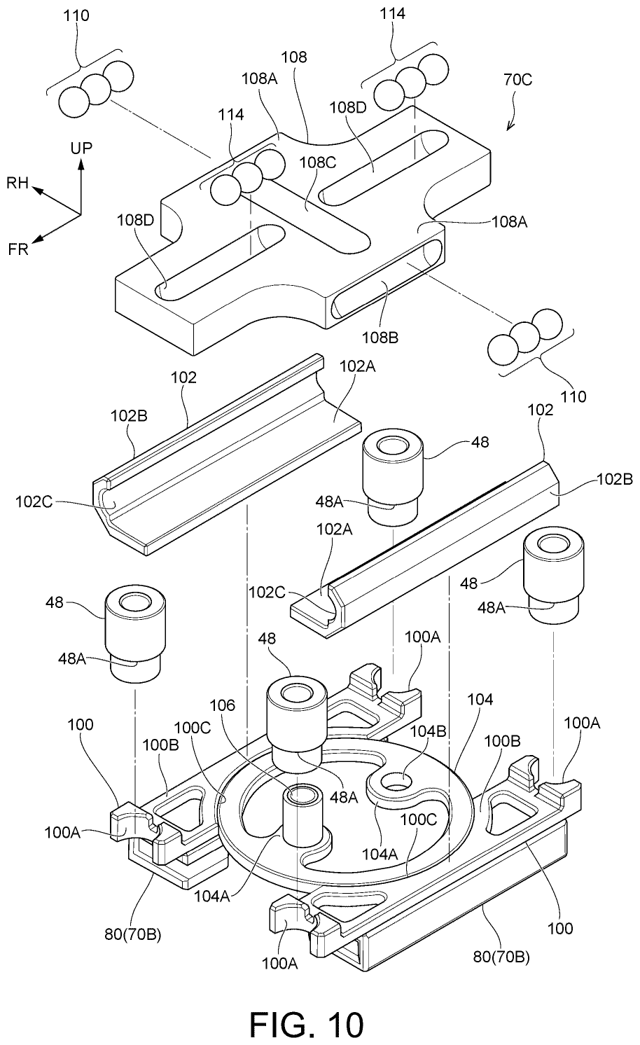

As shown in FIG. 3, FIG. 4, FIG. 6, and FIG. 10, the vibration reduction mechanism part 70C is accommodated in the rear part of the case body 42 on the upper side of the reciprocating motion mechanism part 70B. The vibration reduction mechanism part 70C is configured to include a left-right pair of base members 100, a left-right pair of guide members 102, a ring member 104 as a third drive member, and a counterweight 108.

The base member 100 is arranged at a lower end of the vibration reduction mechanism part 70C and functions as a base of the vibration reduction mechanism part 70C. The base member 100 is formed in a substantially rectangular plate shape with the up-down direction as the plate thickness direction and the front-rear direction as the longitudinal direction. The base member 100 is arranged on the upper side of the guide metal 80 (see FIG. 3, FIG. 4, and FIG. 10). A front end and a rear end of the base member 100 are arranged adjacent to the upper side of the rear fixing boss 42E (see FIG. 3 and FIG. 5). A positioning recess 100A (see FIG. 5 and FIG. 10) is formed through both ends in the front-rear direction of the base member 100 in the up-down direction. The positioning recess 100A is formed in a concave shape open outward in the front-rear direction, and is formed in an arc shape centered on an axis line of the fixing sleeve 48 in plan view. Specifically, a radius of the positioning recess 100A substantially matches a radius of the lower part of the fixing sleeve 48. A portion of the lower part of the fixing sleeve 48 is fitted into the positioning recess 100A, and a position of the base member 100 is determined by the fixing sleeve 48. The stepped part 48A of the fixing sleeve 48 is arranged adjacent to the upper side of an edge of the positioning recess 100A. Accordingly, the base member 100 is fixed to the case body 42 by the fixing sleeve 48.

As described above, the base member 100 is arranged adjacent to the upper side of the guide metal 80. Hence, the guide metal 80 is sandwiched in the up-down direction between the base member 100 and the installation part 42F of the case body 42, and is fixed to the case body 42. That is, the base member 100 constitutes the base of the vibration reduction mechanism part 70C, and is also configured as a stopper component that restricts upward movement of the guide metal 80 (reciprocating motion mechanism part 70B) and the gear 71 (gear mechanism part 70A).

A base accommodation part 100B is formed on an upper surface of the base member 100 except for a front end and a rear end. The base accommodation part 100B is formed in a concave shape one step lower than the front and rear ends of the base member 100, and is penetrated in the left-right direction. A guide recess 100C (see FIG. 10) is formed in an inner side part in the left-right direction of an intermediate part in the front-rear direction of the base member 100. The guide recess 100C is formed in an arcuate concave shape centered on an axis line of the gear 71 in plan view, and is open inward in the left-right direction. In detail, a radius of the guide recess 100C is set larger than a radius of the relief recess 80D of the guide metal 80. The guide recess 100C is arranged radially outside the relief recess 80D in plan view.

The left-right pair of guide members 102 extend in the front-rear direction, and are formed in a substantially L-shaped plate shape as viewed in the front-rear direction. Specifically, the guide member 102 is configured to include: a lower wall 102A, constituting a lower end of the guide member 102; and a sidewall 102B, extending upward from an outer end in the left-right direction of the lower wall 102A. The lower wall 102A of the guide member 102 is fitted into the base accommodation part 100B of the base member 100, and the guide member 102 is placed on the base member 100. Movement of the base member 100 in the front-rear direction is restricted by a front end surface and a rear end surface of the base accommodation part 100B in the base member 100. On the sidewall 102B of the guide member 102, a ball groove 102C extending in the front-rear direction is formed on an inner surface in the left-right direction. The ball groove 102C is formed in a substantially semicircular shape open inward in the left-right direction as viewed in the front-rear direction, and is penetrated in the front-rear direction.

The ring member 104 is formed in a substantially annular plate shape with the up-down direction as the plate thickness direction. The ring member 104 is arranged between the pair of base members 100. Specifically, both side parts in the left-right direction of the ring member 104 are arranged within the guide recess 100C of the base member 100, and an outer periphery of the ring member 104 is arranged adjacent to a radial inside of the guide recess 100C. Accordingly, the ring member 104 is arranged coaxially with the gear 71 on the upper side of the gear 71. Both side parts in the left-right direction of the ring member 104 are arranged between the guide metal 80 and the guide member 102, and movement of the ring member 104 in the up-down direction is restricted by the guide metal 80 and the guide member 102 (see FIG. 4). In detail, both side parts in the left-right direction of the ring member 104 are placed on the upper side of the guide metal 80. The guide metal 80 is configured as a stopping member that receives the ring member 104 from the lower side through the upper surface 80C, and restricts downward movement of the ring member 104.

A pair of ring connecting parts 104A are integrally formed at an inner periphery of the ring member 104. The pair of ring connecting parts 104A protrude radially inward from the ring member 104, and are arranged 180 degrees apart in the circumferential direction of the ring member 104. In one ring connecting part 104A, a connector hole 104B is formed through in the up-down direction. An upper end of the crankpin 75 of the gear 71 is inserted into the connector hole 104B so as to be relatively rotatable (see FIG. 3). Accordingly, the ring member 104 and the gear 71 are connected so as to be integrally rotatable. When the ring member 104 rotates, the outer periphery of the ring member 104 is guided by the guide recess 100C of the guide member 102, and is configured to slide on the upper surface 80C of the guide metal 80. That is, the guide metal 80 is also configured as a support member that slidably supports the ring member 104. The other ring connecting part 104A of the ring member 104 is provided with a crankpin 106 with the up-down direction as the axial direction. The crankpin 106 protrudes upward from the ring member 104.

The counterweight 108 is formed in a substantially rectangular plate shape with the up-down direction as the plate thickness direction and the front-rear direction as the longitudinal direction. A left-right pair of weight collars 108A protruding outward in the left-right direction are formed in an intermediate part in the front-rear direction of the counterweight 108. The counterweight 108 is arranged on the upper side of the ring member 104 with the weight collar 108A arranged on the upper side of the lower wall 102A of the guide member 102.

A first ball groove 108B extending in the front-rear direction is formed on a side surface of the weight collar 108A. The first ball groove 108B is formed in a substantially semicircular shape open outward in the left-right direction in a sectional view as viewed in the front-rear direction. The first ball groove 108B is arranged to face the ball groove 102C of the guide member 102 in the left-right direction (see FIG. 4). A plurality of (three in the present embodiment) first rolling balls 110 as first balls are arranged in the first ball groove 108B and the ball groove 102C. The counterweight 108 is rolling supported by the first rolling ball 110. Accordingly, the counterweight 108 is configured to be slidable in the front-rear direction.

A plurality of (three in the present embodiment) bias sleeves 112 are provided between the guide member 102 and the sidewall of the projecting part 42D of the case body 42 (see FIG. 4 and FIG. 6). The bias sleeve 112 is composed of an elastic material such as rubber, and is formed in a substantially columnar shape with the up-down direction as the axial direction. The bias sleeve 112 is arranged between the guide member 102 and the projecting part 42D in a state of being pressed and crushed in the left-right direction, and biases the guide member 102 inward in the left-right direction. Hence, the first rolling ball 110 is in contact with an inner peripheral surface of each of the first ball groove 108B and the ball groove 102C.

A weight connection hole 108C is formed through the intermediate part in the front-rear direction of the counterweight 108. The weight connection hole 108C is formed in an elongated hole shape with the left-right direction as the longitudinal direction. An upper end of the crankpin 106 of the ring member 104 is inserted into the weight connection hole 108C so as to be relatively movable in the left-right direction and engageable in the front-rear direction. Accordingly, when the ring member 104 rotates, the counterweight 108 may reciprocate in the front-rear direction. Specifically, by rotating the gear 71 and the ring member 104, the counterweight 108 may reciprocate in the front-rear direction in an opposite phase to the plunger 82.

On an upper surface of the counterweight 108, a front-rear pair of second ball grooves 108D are formed in a central part in the left-right direction. The second ball groove 108D is arranged outside the weight connection hole 108C in the front-rear direction. The second ball groove 108D extends in the front-rear direction, and is formed in a substantially semicircular shape open upward in a sectional view as viewed in the front-rear direction. A plurality of (three in the present embodiment) second rolling balls 114 as second balls are arranged in the second ball groove 108D. The second rolling ball 114 is in contact with the lower surface of the case cover 44 and an inner peripheral surface of the second ball groove 108D. Accordingly, the counterweight 108 is rolling supported by the second rolling ball 114.

In the present embodiment, an upper end of the second rolling ball 114 is arranged at the same position as the upper end of the case body 42 including the packing 46, and is in contact with the lower surface of the case cover 44. That is, the second rolling ball 114 is set so as not to protrude from the upper end of the case body 42 including the packing 46. Here, each component constituting the drive mechanism 70 has a dimensional tolerance. Hence, in order to reliably bring the second rolling ball 114 into contact with the lower surface of the case cover 44, the upper end of the second rolling ball 114 may slightly protrude from the upper end of the case body 42 including the packing 46 in consideration of the dimensional tolerances of the components. That is, in the present invention, the fact that the drive mechanism 70 is accommodated so as not to protrude upward from the opening 42M of the case body 42 includes a case where the upper end of the second rolling ball 114 slightly protrudes from the upper end of the case body 42 including the packing 46. In the present invention, the fact that the drive mechanism 70 is accommodated so as not to protrude upward from the opening 42M of the case body 42 indicates that the drive mechanism 70 is located below a position of a side end (upper end) in a predetermined direction (upward direction) of the case body 42 including the opening 42M that opens in the predetermined direction. In this case, the predetermined direction can also be said to be an assembly direction of the case body 42 and the case cover 44. The assembly direction of the case body 42 and the case cover 44 is not limited to the up-down direction. That is, the upper surface of the case body 42 may be configured to be inclined with respect to the front-rear direction or the left-right direction, so that the case cover 44 may be assembled to the upper surface of the case body 42.

### (Effects)

Next, effects of the electric cutting device 10 of the present embodiment are described.

In the cutting using the electric cutting device 10 configured as described above, the operator performs a pulling operation on the trigger 22, thereby operating the motor 60 by the control part 26. Accordingly, the gear 71 meshed with the gear part 61A of the drive shaft 61 in the motor 60 rotates. As a result, the plunger 82 of the reciprocating motion mechanism part 70B connected to the crankpin 75 of the gear 71 reciprocates in the front-rear direction together with the blade 95. Thus, the cutting is performed on the material to be cut.

When the gear 71 rotates, the ring member 104 connected to the crankpin 75 of the gear 71 rotates integrally with the gear 71. Accordingly, the counterweight 108 connected to the crankpin 106 of the ring member 104 reciprocates in the front-rear direction. The crankpin 75 and the crankpin 106 are arranged 180 degrees apart in the circumferential direction of the ring member 104. Hence, the reciprocation of the counterweight 108 in the front-rear direction is in an opposite phase to the reciprocation of the plunger 82 and the blade 95 in the front-rear direction. Accordingly, the vibration reduction mechanism part 70C acts as a dynamic vibration absorber, and vibration caused by the reciprocation of the plunger 82 and the blade 95 is reduced by the vibration reduction mechanism part 70C.

Here, in the reciprocating motion mechanism part 70B of the drive mechanism 70 of the electric cutting device 10, the connector 83 of the plunger 82 is inserted into the slit 80A of the guide metal 80 so as to be movable in the front-rear direction. Accordingly, the guide metal 80 is configured as a guide member that receives the connector 83 from both sides in the up-down direction and guides movement of the connector 83 in the front-rear direction. The guide metal 80 is arranged adjacent to the upper side of the gear 71 constituting the gear mechanism part 70A. Accordingly, the guide metal 80 acts as a stopping member that receives from the upper side the gear 71 moving upward (due to a thrust force, for example), and restricts upward movement of the gear 71. Hence, in the gear mechanism part 70A, upward movement of the gear 71 can be restricted by utilizing the guide metal 80 of the reciprocating motion mechanism part 70B. That is, in the gear mechanism part 70A, upward movement of the gear 71 can be restricted without separately providing a member that restricts upward (toward one side in the thrust direction) movement of the gear 71. Accordingly, an increase in the number of components of the drive mechanism 70 (gear mechanism part 70A) can be suppressed and the cost of the electric cutting device 10 can be reduced. The guide metal 80 may be a component extending upward and supporting the counterweight 108. In this case, the guide metal 80 functions as a member that supports one rotating member (gear 71) while supporting two sliding members (plunger 82 and counterweight 108). At that time, by canceling the support of the counterweight 108 by the rolling ball (that is, using a slide bearing type), while heat is likely to be generated, the number of components can be significantly reduced. The vertical positions of the plunger 82 and the counterweight 108 may be swapped, so that the gear 71 is supported by a component that slidably supports the counterweight 108.

The lower surface 80B of the guide metal 80 is configured as a receiving surface that receives (supports) the gear 71, and is installed in the installation part 42F of the case body 42. Accordingly, the guide metal 80 can be installed in the inner case 40 with the lower surface 80B of the guide metal 80 that receives the gear 71 as a reference. Hence, the gear 71 and the guide metal 80 can be accommodated in the inner case 40 while relative positional shift between the gear 71 and the guide metal 80 in the up-down direction is suppressed.

As described above, in the guide metal 80, the lower surface 80B is configured as a receiving surface that receives (supports) the gear 71. The connector 83 of the plunger 82 is inserted into the slit 80A formed in the intermediate part in the up-down direction of the guide metal 80. Accordingly, while the gear 71 is arranged adjacent to the lower side of the guide metal 80, the plunger 82 (connector) can be arranged in the intermediate part in the up-down direction of the guide metal 80. This can contribute to size reduction of the drive mechanism 70 in the up-down direction.

The guide metal 80 is arranged on the upper side of the outer periphery of the gear 71. Accordingly, when the gear 71 moving upward is received by the lower surface 80B of the guide metal 80, the outer periphery of the gear 71 contacts the lower surface 80B of the guide metal 80 and slides on the lower surface 80B of the guide metal 80. Accordingly, compared to the case where the entire gear 71 contacts the lower surface 80B of the guide metal 80, sliding resistance of the gear 71 when the gear 71 rotates can be reduced.

The pair of guide metals 80 are arranged apart in the left-right direction in the case body 42. Accordingly, by the pair of guide metals 80, both side parts in the left-right direction of the connector 83 of the plunger 82 can be movably supported, and both side parts in the left-right direction of the gear 71 moving upward can be received. Accordingly, support performance of the guide metal 80 for the connector 83 can be improved, and the gear 71 moving upward can be received in a well-balanced manner by the guide metal 80.

The crankpin 75 of the gear 71 is arranged between the left-right pair of guide metals 80. Even if the gear 71 and the guide metal 80 are arranged adjacent to each other in the up-down direction, the crankpin 75 can be arranged between the left-right pair of guide metals 80, and the rotational force of the gear 71 can be transmitted to the connector 83 (plunger 82).

The ring member 104 in the vibration reduction mechanism part 70C is arranged adjacent to the upper side of the guide metal 80, and the guide metal 80 receives the ring member 104 from the lower side. Accordingly, downward movement of the ring member 104 can be restricted by utilizing the guide metal 80 that movably supports the plunger 82. Hence, in the vibration reduction mechanism part 70C, there is no need to separately provide a member that restricts downward movement of the ring member 104. Accordingly, an increase in the number of components of the drive mechanism 70 can further be suppressed and the cost of the electric cutting device 10 can be reduced. The size of the drive mechanism 70 in the up-down direction can be effectively reduced.

The ring member 104 is connected to the gear 71 by the crankpin 75 of the gear 71. That is, the gear 71, the plunger 82, and the ring member 104 can be connected by the crankpin 75 arranged between the left-right pair of guide metals 80. Accordingly, in the drive mechanism 70, an efficient arrangement structure can be realized, and the drive mechanism 70 can be made compact.

The guide metal 80 is composed of a single component. This can contribute to cost reduction of the guide metal 80 alone.

The guide metal 80 is composed of a sintered material, and the guide metal 80 is impregnated with a lubricant. Accordingly, the gear 71, the connector 83, and the ring member 104 are received by the guide metal 80, and sliding resistance when the gear 71, the connector 83, and the ring member 104 slide on the guide metal 80 can be reduced. Accordingly, for example, durability of the drive mechanism 70 can be improved. Since the gear 71 is supported (in the thrust direction) by the rolling ball 50, generation of frictional heat due to support can be suppressed, and durability of the drive mechanism can be improved. Furthermore, since the downward thrust force acting on the gear 71 is absorbed by the buffer rubber 50B, durability of the drive mechanism can be improved. In the present embodiment, the buffer rubber 50B made of rubber is used as the elastic body. However, other materials may be used if they are elastically deformable. For example, rubber made of urethane or a metal spring may be used.

In the electric cutting device 10, the inner case 40 is configured to include the case body 42 of a box shape open upward, and the case cover 44 that closes the opening 42M of the case body 42. The drive mechanism 70 is accommodated in the inner case 40 and is arranged so as not to protrude upward from the opening 42M of the case body 42. Hence, the case cover 44 can be formed into a flat plate shape with the up-down direction as the plate thickness direction, and the opening 42M of the case cover 44 can be closed. Accordingly, by subjecting a metal plate material to pressing (punching), the case cover 44 can be formed. Accordingly, for example, compared to the case where the case cover 44 is made by casting, the cost of the case cover 44 and the inner case 40 can be reduced.

The case cover 44 is fastened and fixed to the case body 42 by the fixing bolt BL1 and the fixing bolt BL2. The case body 42 is provided with the fixing sleeve 48 that is fastened together with the case cover 44 to the case body 42. The lower part of the fixing sleeve 48 is fitted into the positioning recess 100A of the base member 100 in the vibration reduction mechanism part 70C, and the position of the base member 100 is determined by the fixing sleeve 48. The stepped part 48A of the fixing sleeve 48 is arranged adjacent to the upper side of the edge of the positioning recess 100A, and the base member 100 is fixed to the case body 42. Accordingly, by utilizing the fixing bolt BL1 and the fixing sleeve 48 for fixing the case cover 44 to the case body 42, the base member 100 can be fixed to the case body 42 while being positioned.

The base member 100 constitutes a portion of the vibration reduction mechanism part 70C. The base member 100 is arranged adjacent to the upper side of the guide metal 80 of the reciprocating motion mechanism part 70B. Accordingly, by the base member 100, upward movement of the reciprocating motion mechanism part 70B and the gear mechanism part 70A can be restricted. Thus, the base member 100 co-fastened to the case body 42 with the case cover 44 and the fixing sleeve 48 functions as a stopper member of the gear mechanism part 70A and the reciprocating motion mechanism part 70B, and an accommodation state of the gear mechanism part 70A and the reciprocating motion mechanism part 70B in the case body 42 can be well maintained.

The gear 71 is rotatably provided at the bottom of the case body 42 with the up-down direction as the axial direction. Furthermore, the shaft accommodation part 42C that communicates the inside and the outside of the case body 42 is provided at the bottom of the case body 42. The drive shaft 61 of the motor 60 is accommodated in the shaft accommodation part 42C. Accordingly, the power of the motor 60 can be transmitted to the gear 71 while the motor 60 is arranged outside the case body 42.

The motor holder 42K extending downward is formed at the rear end of the case body 42. The motor 60 is held by the motor holder 42K. Specifically, the motor bearing 66 that rotatably supports the lower end of the drive shaft 61 of the motor 60 is held by the bearing holder 67. The bearing holder 67 is fitted into the motor holder 42K from the lower side, and is held by the motor holder 42K. Accordingly, the motor 60 is formed into a unit with the inner case 40 accommodating the drive mechanism 70, and the inner case 40 and the motor 60 formed into a unit can be assembled to the housing 20. Accordingly, the ease of assembling the electric cutting device 10 can be improved.

In the reciprocating motion mechanism part 70B, the guide metal 80 is sandwiched in the up-down direction between the base member 100 and the installation part F of the projecting part 42D of the case body 42, and movement of the guide metal 80 in the up-down direction is restricted. As described above, by the guide metal 80, the gear 71 moving upward is received, and upward movement of the gear 71 is restricted. Accordingly, the guide metal 80 that restricts upward movement of the gear 71 can be fixed to the case body 42 by the base member 100. That is, by the fixing bolt BL1 and the fixing sleeve 48, while the case cover 44, the base member 100, and the guide metal 80 are fixed to the case body 42, upward movement of the gear 71 can be restricted.

The insertion part 42J through which the output shaft 84 of the plunger 82 is inserted is formed at the front end of the case body 42. Accordingly, the front end of the output shaft 84 can be arranged outside the inner case 40, and the blade attachment mechanism 92 can be arranged outside the inner case 40.

In the vibration reduction mechanism part 70C, the counterweight 108 is rolling supported by the first rolling ball 110 and the second rolling ball 114. The second rolling ball 114 is arranged between and in contact with the counterweight 108 and the case cover 44. Accordingly, the counterweight 108 can be supported by utilizing the case cover 44 that closes the opening 42M of the case body 42. Thus, contribution can be made to a reduction in the number of components of the vibration reduction mechanism part 70C, and the cost of the drive mechanism 70 can be effectively reduced. The balls (first rolling ball 110 and second rolling ball 114) that support the counterweight 108 are configured to move while rolling so as to move relative to both the counterweight 108 and the guide member 102 in the front-rear direction. Thus, generation of frictional heat due to reciprocating drive of the counterweight 108 can be suppressed, and the life of components can be extended.

In the inner case 40, the vibration reduction mechanism part 70C (counterweight 108) is accommodated on the upper side of the reciprocating motion mechanism part 70B (plunger 82). Furthermore, the inner case 40 is assembled to the housing 20 so that the reciprocating motion mechanism part 70B (plunger 82) is arranged on the upper side of the central part 20B1 in the up-down direction of the handle housing part 20B in the housing 20. Specifically, the central part 20B1 in the up-down direction of the handle housing part 20B is arranged lower than the axis line CL of the output shaft 84 of the reciprocating motion mechanism part 70B. Hence, during cutting, while the operator grasps the handle housing part 20B located on the lower side of the plunger 82, vibration generated by the plunger 82 is reduced by the vibration reduction mechanism part 70C arranged on the upper side of the plunger 82. Accordingly, during cutting, the front end of the blade 95 acts to draw an elliptical trajectory as viewed in the left-right direction. Accordingly, cutting performance of the electric cutting device 10 with respect to the material to be cut can be improved.

### DESCRIPTION OF REFERENCE NUMERALS

10: electric cutting device (work machine); 40: inner case (case); 42F: installation part; 60: motor; 70: drive mechanism; 71: gear (first drive member); 75: crankpin (connecting part); 80: guide metal (support member); 80A: slit (second receiving part); 80B: lower surface (first receiving part); 82: plunger (second drive member); 95: blade (tip tool); 104: ring member (third drive member)

To the claims:

1. A work machine, comprising:
a motor;
a drive mechanism, connected to the motor and operating a tip tool; and
a case, accommodating the drive mechanism, wherein
the drive mechanism is configured to comprise:
a first drive member, rotationally driven by the motor about an axis extending in a first direction;
a second drive member, reciprocally driven by the first drive member and capable of holding the tip tool; and
a support member, at least partially positioned between the first drive member and the second drive member in the first direction in the case, restricting movement of the first drive member in the first direction, and supporting the second drive member so that the second drive member is reciprocally drivable.

2. (canceled)

3. The work machine according to claim 1, wherein
the first drive member is arranged on one side of the support member; and
the support member is configured to comprise:
a first receiving part, configured as a facing surface facing the first drive member, and supporting the first drive member; and
a second receiving part, configured as a slit opened in a direction orthogonal to the first direction and supporting the second drive member.

4. The work machine according to claim 1, wherein
the first drive member is a gear configured to be rotatable with the first direction as an axial direction.

5. The work machine according to claim 4, wherein
the support member is arranged to face the gear in the first direction.

6. The work machine according to claim 1, wherein
the second drive member extends in a second direction orthogonal to the first direction, and the second drive member reciprocates in the second direction in response to operation of the drive mechanism; and
the tip tool is connected to one end of the second drive member, and the other end of the second drive member is movably guided in the second direction by the second receiving part.

7. The work machine according to claim 1, wherein
the second drive member extends in a second direction orthogonal to the first direction; and
the drive mechanism comprises a pair of the support members arranged spaced apart in a third direction orthogonal to the first direction and the second direction.

8. The work machine according to claim 7, wherein
the first drive member is provided with a connecting part; and
the connecting part connects the first drive member and the second drive member, transmits power of the motor to the second drive member, and is arranged between the pair of the support members in the third direction.

9. The work machine according to claim 1, wherein
the drive mechanism comprises a third drive member operated by the power of the first drive member; and
the third drive member is arranged opposite the first drive member with respect to the support member in the first direction, and the support member operably receives the third drive member.

10. The work machine according to claim 9, wherein
the first drive member is provided with a connecting part; and
the connecting part connects the first drive member and the second drive member and transmits power of the motor to the second drive member, and the connecting part connects the first drive member and the third drive member and transmits the power of the motor to the third drive member.

11. The work machine according to claim 1, wherein
the support member is configured as a single component.

12. The work machine according to claim 1, wherein
the support member is composed of a sintered material, and the support member is impregnated with a lubricant.

13. A work machine, comprising:
a motor;
a drive mechanism, connected to the motor and operating a tip tool; and
a case, accommodating the drive mechanism, wherein
the drive mechanism is configured to comprise:
a first drive member, rotationally driven by the motor about an axis extending in a first direction;
a second drive member, reciprocally driven by the motor in the second direction orthogonal to the first direction and capable of holding the tip tool; and
an elastic body, elastically deforming when pressed by the first drive member that leaves the second drive member along the first direction.

14. A work machine, comprising:
a motor;
a drive mechanism, connected to the motor and operating a tip tool; and
a case, accommodating the drive mechanism, wherein
the drive mechanism is configured to comprise:
a first drive member, rotationally driven by the motor about an axis extending in a first direction;
a second drive member, reciprocally driven by the motor and capable of holding the tip tool; and
a support member, restricting movement of the first drive member in the first direction, and supporting the second drive member so that the second drive member is reciprocally drivable,
wherein the first drive member is arranged on one side of the support member, and the support member is configured to comprise:
a first receiving part, configured as a facing surface facing the first drive member, and supporting the first drive member; and
a second receiving part, configured as a slit opened in a direction orthogonal to the first direction and supporting the second drive member.
